(19) United States
(12) Patent Application Publication
(10) Pub. No.: US 2026/0195392 A1
(43) Pub. Date: Jul. 9, 2026

(54) MACHINE LEARNING-BASED FRAMEWORK FOR USER INTERACTION COMMUNICATION MODALITIES

(71) Applicant: Wells Fargo Bank, N.A., San Francisco, CA (US)

(72) Inventors: Jason Franklin Frye, Monroe, NC (US); Maximilian Fuchs, Charlotte, NC (US); Steven A. Jolley, Chester, SC (US); Eric-Andre Vigroux, New Rochelle, NY (US)

(21) Appl. No.: 19/009,731

(22) Filed: Jan. 3, 2025

(51) Int. Cl. G06F 16/9535; H04L 67/02

(52) U.S. Cl. CPC G06F 16/9535; H04L 67/02

(57) ABSTRACT

A method may include receiving a recommendation request from a computing device, the recommendation request formatted as an application programming interface (API) call with an account identifier, an intended recipient identifier, and an intended action; selecting a machine learning model from a plurality of machine learning models based on the account identifier, intended recipient identifier and intended action; generating an input data structure based on the recommendation request according to an input format of the machine learning model; executing the machine learning model with the input data structure; subsequent to the executing, modifying the intended action to a recommended action based on an output of the machine learning model; transmitting the recommended action as a response to the API call.

### BACKGROUND

Individual practices, such as those in financial services, healthcare, and real estate, face the ongoing challenge of making numerous client communication, style, and engagement decisions. These decisions are complicated by the diverse needs and preferences of clients, the varying regulatory requirements across industries, and alignment with industry standards while also pursuing the practice's unique goals.

### BRIEF DESCRIPTION OF THE DRAWINGS

In the drawings, which are not necessarily drawn to scale, like numerals may describe similar components in different views. To easily identify the discussion of any particular element or act, the most significant digit or digits in a reference number refer to the figure number in which that element is first introduced. Like numerals having different letter suffixes may represent different instances of similar components. Some embodiments are illustrated by way of example, and not limitation, in the figures of the accompanying drawing.

FIG. 1 is an illustration of components of a client device and an application server, according to various examples.

FIG. 2 is a diagram illustrating pipelines for training and using a machine learning model, according to various examples.

FIG. 3 illustrates an aspect of the subject matter in accordance with one embodiment.

FIG. 4 illustrates a method 400 in accordance with one embodiment.

FIG. 5 is a block diagram illustrating a machine in the example form of computer system, within which a set or sequence of instructions may be executed to cause the machine to perform any one of the methodologies discussed herein, according to various examples.

### DETAILED DESCRIPTION

Developing personalized recommendations for service providers (e.g., financial advisors, medical practices, travel agents, and real estate agents) involves significant technical challenges that extend beyond simple data processing. One technical hurdle lies in the data integration and normalization process. Different practices (e.g., an individual financial advisor) may use varied systems and formats for data storage and management, from spreadsheets to enterprise database systems. Additionally, there may be no standardized data schema within those storage systems.

Furthermore, each practice may have distinct goals, preferences, and communication styles. Thus, a standard recommendation system would not consider personalized strategies to address a practice's unique needs effectively. The challenges are compounded when making recommendations when specific clients (e.g., people receiving the service) are considered. For example, each client may have preferred goals, preferences, and communication styles.

Another technical challenge relates to the diverse computing devices and electronic platforms (e.g., scheduling systems, email clients, and customer relationship management (CRM) tools)) used by service providers. For example, each platform may have unique data structures, APIs, and integration points.

Given the problems with existing recommendation solutions, systems and methods are described herein that provide dynamic and personalized recommendations using a diverse set of machine learning models. Throughout this disclosure, the term “provider user” may refer to an individual or organization that provides a service. For example, a provider user may be a particular financial advisor or real estate practice. A “receiver user” may refer to an individual or organization that receives service from a providing user. For example, a receiver user may be a client of a particular financial advisor.

The methods described include advanced data ingestion and transformation systems capable of handling multiple file formats and database structures, from structured financial data to unstructured communication logs and social media feeds. The recommendations are also presented in a variety of contexts. For example, a dashboard interface may be presented to a provider user that includes metrics (e.g., growth, revenue, client base size) on their practice and suggestions for improving their metrics. The dashboard interface may include comparisons to similar practices and their respective metrics. The dashboard interface may further include trendline data on how a provider user's metrics have changed.

Another recommendation context may be when a provider user communicates with a receiver user. A personalized machine learning model that has been trained may be selected based on the preferences and goals of the provider and receiver user. Then, the text of an email may be modified by the selected machine learning model and presented as a recommended action to the providing user.

The following description outlines specific examples to provide a thorough understanding of various inventive aspects. It will be evident, however, to one skilled in the art that the present invention may be practiced without these specific details. References in the specification to “one example,” “an example,” “an illustrative example,” etc., indicate that the example described may include a particular feature, structure, etc. Still, every example may not necessarily include that particular feature. Additionally, such phrases do not imply a single example, and the features may be incorporated into other examples described. It may be appreciated that lists in the form of “at least one A, B, and C” may mean (A); (B); (C): (A and B); (B and C); or (A, B, and C). Similarly, items listed in the form of “at least one of A, B, or C” can mean (A); (B); (C): (A and B); (B and C); or (A, B, and C). Furthermore, using such phrases does not negate the possibility of other options (e.g., (D)).

Throughout this disclosure, components may perform electronic actions in response to different variable values (e.g., thresholds, user preferences, etc.). As a matter of convenience, this disclosure does not always detail where the variables are stored or how they are retrieved. In such instances, it may be assumed that the variables are stored on a storage device (e.g., Random Access Memory (RAM), cache, hard drive) accessible by the component via an Application Programming Interface (API) or other program communication method. Similarly, the variables may be assumed to have default values should a specific value not be described. End-users or administrators may use user interfaces to edit the variable values.

In various examples described herein, user interfaces are described as being presented to a computing device. The presentation may include data transmitted (e.g., a hypertext markup language file) from a first device (such as a web server) to the computing device for rendering on a display device of the computing device via a web browser. Presenting may separately (or in addition to the previous data transmission) include an application (e.g., a stand-alone application) on the computing device generating and rendering the user interface on a display device of the computing device without receiving data from a server.

Furthermore, the user interfaces are often described as having different portions or elements. Although in some examples, these portions may be displayed on a screen simultaneously, in others, the portions/elements may be displayed on separate screens such that not all portions/elements are displayed simultaneously. Unless explicitly indicated as such, the use of “presenting a user interface” does not infer either one of these options.

Additionally, the elements and portions are sometimes described as being configured for a particular purpose. For example, an input element may be configured to receive an input string, a selection from a menu, a checkbox, etc. In this context, “configured to” may mean presenting a user interface element capable of receiving user input. “Configured to” may additionally mean computer executable code processes interactions with the element/portion based on an event handler. Thus, a “search” button element may be configured to pass text received in the input element to a search routine that formats and executes a structured query language (SQL) query to a database.

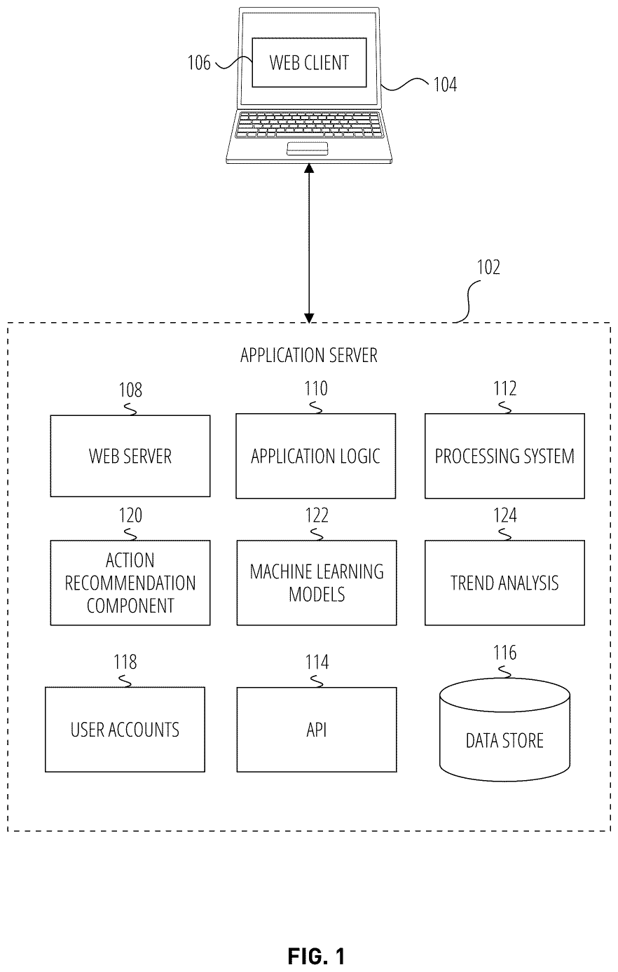

FIG. 1 illustrates the components of a client device and an application server according to various examples. The client device 104 may be a computing device used by a provider user. Accordingly, it may include applications, such as web client 106, to initiate actions with respect to a receiver user. The actions may differ depending on the type of practice of the provider user. For example, a financial advisor may have actions such as initiating a yearly review with their client base, emailing a newsletter, responding to requests from their clients, managing the funds of their clients, etc. A real estate agent may have actions such as scheduling times to show a home, emailing sellers/buyers about closing dates, etc. The applications running on client device 104 may interact with application server 102 to recommend or modify an intended action made by a user of client device 104. In some examples, if an application is web-based, the application may communicate directly to application server 102 (as opposed to through client device 104).

Application server 102 is illustrated as separate elements (e.g., components). However, the functionality of multiple individual elements may be performed by a single element. An element may represent computer program code executable by processing system 112. The program code may be stored on a storage device (e.g., data store 116) and loaded into the memory of the processing system 112 for execution. Portions of the program code may be executed in parallel across multiple processing units. A processing unit may be a grouping of one or more cores of a general-purpose computer processor, a graphical processing unit, an application-specific integrated circuit, or a tensor processing core. Furthermore, the grouping may operate on a single device or multiple devices (either collocated or geographically dispersed). Accordingly, code execution using a processing unit may be performed on a single device or distributed across multiple devices. In some examples, using shared computing infrastructure, the program code may be executed on a cloud platform (e.g., MICROSOFT AZURE® and AMAZON EC2®). Furthermore, although FIG. 1 depicts much of the functionality for data transformation and machine learning models as occurring within application server 102, the functionality may be performed on the client device 104 in various examples.

Client device 104 may be a computing device which may be, but is not limited to, a smartphone, tablet, laptop, multi-processor system, microprocessor-based or programmable consumer electronics, game console, set-top box, or other device that a user utilizes to communicate over a network. In various examples, a computing device includes a display module (not shown) to display information (e.g., specially configured user interfaces). In some embodiments, computing devices may comprise one or more of a touch screen, camera, keyboard, microphone, or Global Positioning System (GPS) device.

Client device 104 and application server 102 may communicate via a network (not shown). The network may include local-area networks (LAN), wide-area networks (WAN), wireless networks (e.g., 802.11 or cellular network), Public Switched Telephone Network (PSTN), ad hoc networks, cellular, personal area networks or peer-to-peer (e.g., Bluetooth®, Wi-Fi Direct), or other combinations or permutations of network protocols and network types. The network may include a single Local Area Network (LAN), Wide-Area Network (WAN), or combinations of LANs or WANs, such as the Internet.

In some examples, the communication may occur using an application programming interface (API) such as API 114. An API provides a method for computing processes to exchange data. A web-based API (e.g., API 114) may permit communications between two or more computing devices, such as a client and a server. The API may define a set of HTTP calls according to Representational State Transfer (RESTful) practices. For example, A RESTful API may define various GET, PUT, POST, and DELETE methods to create, replace, update, and delete data stored in a database(e.g., data store 116).

Web client 106 may format an API for a recommendation request that includes the parameters of an account identifier, an intended recipient identifier, and an intended action. The account identifier may correspond to an identifier (e.g., email, unique alphanumeric sequence, etc.) of the provider user as stored in user accounts 118. The intended recipient identifier may correspond to a receiver user. As discussed in more detail in the following figures, the intended action may be a draft of an e-mail or a decision to change the frequency of communication with an intended recipient. Application server 102 may process the API call and respond with a recommended action, such as changing the content of the email or frequency of communication.

APIs may also be defined in frameworks provided by an operating system (OS) to access data in an application that an application may not regularly be permitted to access. For example, the OS may define an API call to obtain the current location of a mobile device on which the OS is installed. In another example, an application provider may use an API call to request a user be authenticated using a biometric sensor on the mobile device. By segregating any underlying biometric data—e.g., by using a secure element—the risk of unauthorized transmission of the biometric data may be lowered.

Application server 102 may include web server 108 to enable data exchanges with client device 104 via web client 106. Although generally discussed in the context of delivering webpages via the Hypertext Transfer Protocol (HTTP), other network protocols may be utilized by web server 108 (e.g., File Transfer Protocol, Telnet, Secure Shell, etc.). A user may enter a uniform resource identifier (URI) into web client 106 (e.g., the INTERNET EXPLORER® web browser by Microsoft Corporation or SAFARI® web browser by Apple Inc.) that corresponds to the logical location (e.g., an Internet Protocol address) of web server 108. In response, web server 108 may transmit a web page rendered on a client device's display device (e.g., a mobile phone, desktop computer, etc.).

Additionally, web server 108 may enable users to interact with one or more web applications provided on a transmitted web page. A web application may provide user interface (UI) components rendered on a display device of the client device 104. The user may interact (e.g., select, move, enter text into) with the UI components, and, based on the interaction, the web application may update one or more portions of the web page. A web application may be executed in whole or in part locally on client device 104. The web application may populate the UI components with data from external or internal sources (e.g., data store 116) in various examples.

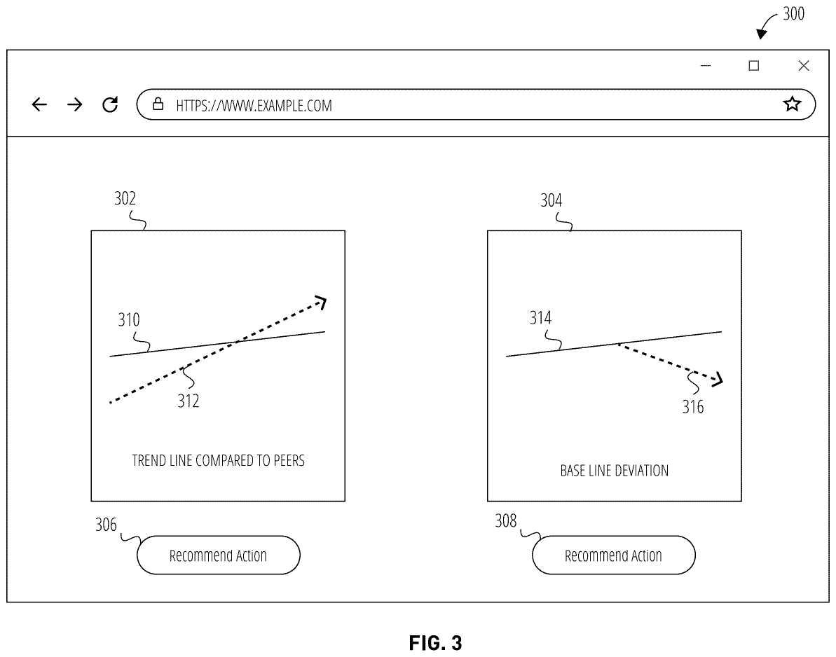

In various examples, the web application provides a dashboard interface with information on a provider user's practice. The dashboard interface may provide input elements where users enter their goals (e.g., grow a client base, increase customer satisfaction, etc.) and associated metrics for tracking progress. Input elements may also be presented for an intended action and intended recipient identifier, which may be used to transmit a request for a recommended action to take. An example dashboard interface is discussed in greater detail in FIG. 3. In various examples, the goal data may be stored in a relational database table within data store 116, with each row representing a specific goal and columns corresponding to the various attributes of the goal.

The web application may be implemented as a plug-in to an existing application. For example, the web application may be part of an e-mail client. In such instances, the plug-in may communicate with application server 102 to receive modifications to potential e-mail correspondence.

The web application may be executed according to application logic 110. Application logic 110 may use the various elements of application server 102 to implement the web application. For example, application logic 110 may issue API calls to retrieve or store data from data store 116 and transmit it for display on client device 104. Similarly, data entered by a user into a UI component may be transmitted using API 114 back to the web server. Application logic 110 may use other elements (e.g., action recommendation component 120, machine learning models 122, trend analysis component 124, etc.) of application server 102 to perform functionality associated with the web application as described further herein.

Data store 116 may store data that is used by application server 102. Data store 116 is depicted as a singular element but may be multiple data stores. The data store 116 may include several databases of varying model architectures such as, but not limited to, a relational database (e.g., SQL), a non-relational database (NoSQL), a flat-file database, an object model, a document details model, graph database, shared ledger (e.g., blockchain), or a file system hierarchy. Data store 116 may store data on one or more storage devices (e.g., a hard disk, random access memory (RAM), etc.). The storage devices may be in standalone arrays, part of one or more servers, and located in one or more geographic areas. Data structures may be implemented in several ways depending on the programming language of an application or the database management system used by an application. For example, if C++ is used, the data structure may be implemented as a struct or class. In the context of a relational database, a data structure may be defined in a schema.

User accounts 118 may include user profiles on users of application server 102. A user profile may include credential information such as a username and hash of a password. A user may enter their username and plaintext password on a login page of application server 102 to view their user profile information or interfaces presented by application server 102 in various examples.

A user profile may also include authorization to access other services (e.g., customer relation software) where the user has an account. The authorizations may include a token (e.g., using OAuth) or login credentials that authorize application server 102 to retrieve data from the other services in a defined format, such as JavaScript Object Notation (JSON) or extensible markup language (XML) over an API. A reciprocal authorization may also be stored in the user profile that authorizes the other services to access data stored in the user profile. The user profile may include information on a user's practice. For example, the user profile may store the number of clients (e.g., receiver users), revenue, location, etc. This information may be used to find similar practices and determine if a practice is underperforming compared to the practice's peers.

A user account may also store data files that may be used as input data to a machine learning model. For example, a spreadsheet file may include the names of receiver users and their communication preferences (e.g., text, e-mail, in-person meetings). The spreadsheet may include entries for when the provider user contacted a receiver user.

“Associated” in the context of linking information to a user account or profile (or other data linkages described herein) may be implemented differently depending on the underlying database system. For example, in a relational database management system (RDBMS), “associated” may refer to the relationship between tables. The relationship could be one-to-one, one-to-many, or many-to-many, established through foreign key constraints. For example, in a one-to-many relationship, a record in Table A (e.g., a user profile table) may be associated with multiple records in Table B (e.g., a data file table) using a foreign key in Table B that references the primary key in Table A.

Action recommendation component 120 may include logic for responding to recommendation requests from computing devices associated with a providing user. The response to a recommendation request may be a recommended action. The type of recommended action may differ depending on the type of recommendation request. The type of recommendation request may be determined by an API call received.

For example, a defined API call called “Recommend_Communication_Style” may include input parameters of an intended recipient identifier and communication type (e.g., email, phone, etc.). The recommended action may be the type of communication style to use. Another API call may be used to request a modification to a set of text that includes input parameters of the intended recipient identifier and text to be modified. In such an instance, the recommended action may be the modified text. Yet another recommendation request may request a change to the frequency of communications. The recommended action may be a quantitative value (e.g., once per week) or a qualitative (e.g., decrease in frequency).

The type of recommendation request may be associated with (e.g., as part of an executed function) one or more machine learning models (e.g., machine learning models 122). For example, part of the logic of action recommendation component 120 may be to execute a machine learning model to formulate the recommended action. A machine learning model may be trained for a specific provider user in various examples. For example, a base generative artificial intelligence (GAI) model may be fine-tuned using prior communications of the providing user to match the provider user's style. Thus, when text is generated as part of a recommended action, the fine-tuned GAI model for the providing user may be used.

Trend analysis component 124 may be utilized to monitor a provider user's practice over some time and compare it to their goals or a baseline. The trend analysis component 124 may query data from various sources, such as user accounts 118, data store 116, and external APIs, to build a comprehensive view of the provider user's practice performance. This data may include metrics such as client base size, revenue, growth rate, and client satisfaction scores.

In various examples, trend analysis component 124 may generate trend line data that shows how a provider user's metrics have changed over time. This trend line data may be presented on a dashboard interface, allowing the provider user to visualize their progress towards their goals. The dashboard interface may include comparisons to other similar practices and their respective metrics, providing context for the provider user's performance.

Trend analysis component 124 may work with action recommendation component 120 to provide personalized recommendations based on the observed trends. For instance, if the trend analysis component 124 detects that the provider user's client acquisition rate is falling below their goal, it may trigger the action recommendation component 120 to suggest a change in the frequency of communications or content related to marketing.

Trend analysis component 124 may generate a baseline behavior profile across multiple domains for the account identifier (provider user). This baseline profile may be calculated using historical data stored in data store 116, and user accounts 118, encompassing metrics such as client communication frequency, portfolio management activities, and practice growth indicators. The baseline behavior profile may be periodically updated (e.g., quarterly or yearly) by the trend analysis component 124 to account for long-term changes in the provider user's practice.

In various examples, the dashboard interface may display this baseline behavior profile alongside the trend line data, allowing the provider user to visualize their current performance in relation to their established baseline. The baseline may be represented as a reference line or shaded area on the trend line graphs, providing a clear visual indicator of expected behavior.

The trend analysis component 124 may continuously monitor the provider user's actions and compare them to the baseline behavior profile. If the component determines that an intended action deviates from the baseline behavior profile more than a threshold amount (e.g., two standard deviations, 15%, etc.), it may trigger an alert. This alert may be transmitted as a message to a computing device associated with the account identifier, notifying the provider user of the deviation.

In various examples, the dashboard interface may include visual indicators or alerts when current trends begin to deviate significantly from the baseline. These indicators may be color-coded or use other visual cues to draw attention to areas of concern. The interface may also provide breakdowns of the specific metrics deviating from the baseline, allowing the provider user to investigate and address potential issues proactively.

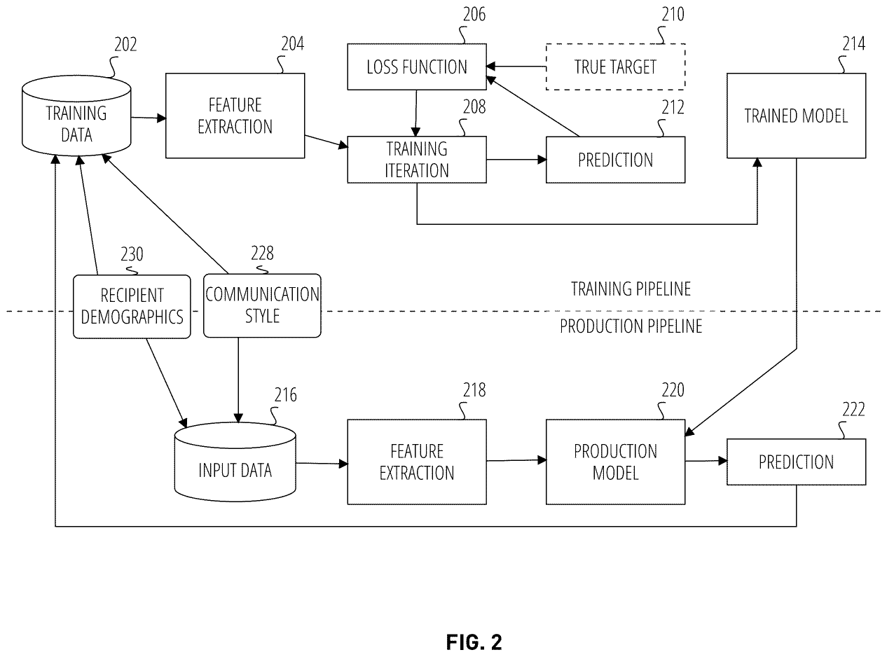

FIG. 2 is a diagram illustrating pipelines for training and using a machine learning model, according to various examples. Machine learning encompasses different algorithms used to predict or classify a data set. In general terms, there are three types of ML algorithms: supervised learning, unsupervised learning, and reinforcement learning.

Supervised learning algorithms may make a prediction based on a labeled data set (e.g., text with a rating of whether it is spam) and are generally used for classification, regression, or forecasting. Some examples of supervised learning algorithms are Naïve Bayes, Support Vector Machines, Linear Regression, Logistic Regression, Decision Trees, Random Forests, and K-Nearest Neighbor. Unsupervised learning algorithms may use an unlabeled data set (e.g., looking for clusters of similar data based on common characteristics). An example of an unsupervised learning algorithm is K-mean clustering.

Reinforcement learning algorithms generally make a prediction/decision, and then a user determines whether the prediction/decision was right—after which the machine learning model may be updated. This type of learning may be helpful when a limited input data set is available.

Neural networks (also called artificial neural networks (ANN)) are a subset of ML algorithms that may be used to solve problems similar to those of the machine learning algorithms listed above. ANNs are computational structures that are loosely modeled on biological neurons. Generally, ANNs encode information (e.g., data or decision-making) via weighted connections (e.g., synapses) between nodes (e.g., neurons). ANNs have many AI applications, such as automated perception (e.g., computer vision, speech recognition, contextual awareness, etc.), automated cognition (e.g., decision-making, logistics, routing, supply chain optimization, etc.), automated control (e.g., autonomous cars, drones, robots, etc.), among others. The weights may be updated using a gradient descent technique during the training process.

Regarding FIG. 2, training a machine learning model begins by collecting training data 202. For example, consider that a machine learning model is being trained to determine the communication style most likely to result in a receiver user having a positive response to a communication. Thus, the training data 202 may include recipient demographics 230 and communication style 228 of past communications to recipients (e.g., e-mails, text messages, social media posts). The recipient demographics 230 may be retrieved from a data store such as user accounts 118 in data store 116 of FIG. 1. A communication style may be a tone categorization output from a natural language processor. For example, the categorizations may be formal, informal, positive, negative, neutral, apologetic, confident, etc.

The training data 202 may be labeled according to past user interaction sessions. Each session may be defined as a sequence of communications (e.g., as retrieved from data store 116) beginning with a communication to a receiver user and concluding with an outcome. For example, the outcomes may be categorized into four labels: ‘Responded Positively,’ ‘Responded Negatively,’ ‘Did not Respond,’ and ‘Ended Relationship.’ Thus, in a generalized form, a training data element may be {[age, gender, location], [communication style]: [outcome]}.

Feature extraction 204 may include normalization and quantification of the training data 202. For example, a vector having one or more dimensions may be generated and include data encoded from each past user interaction session. Numerical data, such as age, may be directly used as vector components after normalization to ensure consistent scale across the dataset. Categorical data, such as communication style, may be encoded numerically, often through one-hot encoding. One-hot encoding represents each possible category/type by a binary vector with a ‘1’ in the position corresponding to the category and ‘0’s elsewhere. For example, a “positive” communication style may be assigned the second element of the vector. Thus, if a communication style is positive, the vector may be [0, 1, 0, . . . ].

A training iteration 208 may include inputting a session, as encoded into a vector format, into a machine learning model (e.g., neural network, k-means clustering algorithm). The model may then output prediction 212. For a neural network, outputting the prediction may include outputting a vector where each vector element represents a possible outcome (e.g., responded positively, etc.). The set of possible outcomes may match the labels in the training data 202.

The prediction 212 may be compared to the true target 210, depending on the model type. A true target may be the actual category of outcome the past communication style resulted in. The loss function 206 evaluates the model's performance (e.g., how well the predictions match the actual outcomes). Based on this evaluation, the model's parameters (like weights in neural networks) are updated to minimize the loss, such as using gradient descent. In other models, like decision trees, the update mechanism might involve choosing different splits in the data or pruning branches to improve the model's accuracy, or for k-means clustering, the centroids may be recalculated. After a stopping condition, such as the number of epochs for neural network or convergence, the model may be considered trained (e.g., trained model 214).

Turning to the production pipeline of FIG. 2, the trained model 214 is used as the production model 220. For example, an e-mail client may have transmitted a recommendation request concerning an email drafted. The recipient demographics 230 of the email's intended recipient may be retrieved from user accounts 118 (e.g., using the email address as a lookup). The body of the email may be input (e.g., input data 216) into an NLP to categorize its content (e.g., the communication style 228). The recipient demographics 230 and communication style 228 may be encoded into an input feature vector at feature extraction 218.

The production model 220 may then generate prediction 222. The output may take several forms depending on how a machine learning model was trained. For example, the machine learning model may have been trained such that the output layer includes several nodes equal to the possible outcomes. The value of each node after an input feature vector has been processed by production model 220 may represent the probability that the current email would result in a respective category.

The production model 220 may be updated based on actual outcomes after an email has been sent and a received determined. For example, training data 202 may be updated to include new labeled data sets as more data (e.g., emails and their responses) becomes available. In this manner, the weights of a machine learning model may become more accurate over time.

FIG. 3 is a dashboard interface, according to various examples. FIG. 3 illustrates dashboard interface 300 with peer trend visualization 302 and base trend visualization 304 with action button 306 and action button 308, respectively. Within peer trend visualization 302, provider trend line 310 is displayed as a solid line, while peer trend line 312 is shown as a dashed line. Within base trend visualization 304, base trend line 314 is illustrated as a solid line, with deviation trend line 316 shown as a dashed line. Dashboard interface 300 includes two visualizations, but more or fewer may be presented without departing from the scope of this disclosure.

The dashboard interface 300 may be presented when a user logs into a web application (e.g., served from a server such as web server 108). The web application may query user accounts 118 and data store 116 to retrieve current metrics and goals of the provider user (e.g., using an account identifier of the provider user). For example, a table may store a column for each metric (e.g., customer satisfaction, number of clients, etc.), a value of the metric, and a period (e.g., date, month, quarter) the value is for. From this data, provider trend line 310 may be generated using chart-generating frameworks. The provider trend line 310 may represent a single metric or multiple metrics.

The peer trend line 312 may be generated based on the average metric(s) for other practices similar to the provider user. The clustering of practices to determine peer groups may be implemented using machine learning models 122. These models may employ unsupervised learning algorithms, such as k-means clustering or hierarchical clustering, to group practices based on multidimensional similarity metrics. The input features for the clustering algorithm may include various practice characteristics stored in user accounts 118, such as location, client demographics, revenue, size of client base, and specific goals.

The clustering algorithm may normalize the features to ensure equal weighting and then compute distances between practices in the multidimensional space (e.g., Euclidian distance, cosine similarity, etc.). Once clusters are formed, each practice is assigned to a cluster, which defines the various peer groups. This process may be periodically re-run by the trend analysis component 124 to account for changes in practice characteristics to ensure that peer groups remain accurate.

Action button 306 may utilize various components from FIG. 1 to obtain a recommended action for improving the provider user's trend line to more closely align with their peers. Action button 306 may trigger a request to action recommendation component 120 API 114 when activated (e.g., clicked).

The action recommendation component 120 may analyze the current state of the provider trend line 310 and peer trend line 312 by querying data store 116, and user accounts 118. Depending on the metric represented by the trend lines, the action recommendation component 120 may select an appropriate machine learning model from machine learning models 122 to generate the recommended action. For instance, if the trend lines represent client acquisition rates, a machine learning model trained using factors such as current marketing strategies, client demographics, and historical performance data may be used. The machine learning model may be trained using a process such as described for FIG. 2 in which the various factors are encoded into a vector format based on past data. The outcome, or loss function, may be the value of the metric.

The action recommendation component 120 may then make adjustments (e.g., up or down) to the values of the provider user's factors (e.g., increased frequency of communications) and input a hypothetical set of values to the machine learning model. The output of the machine learning model may be compared to the metric's current value. If the metric increases, the recommended action may be the adjustment made in the hypothetical. The recommended action may be based on the average of the peer group. For example, suppose the average frequency of communication with clients in the peer group is less than that of the provider user. In that case, the recommended action may be to decrease the provider user's communication frequency. The recommended action may be presented on dashboard interface 300, sent as an email, or push notification, in various examples.

The action button 308 may be used to transmit a recommendation request to action recommendation component 120 for a recommended action concerning trends of the provider user. For example, the trend analysis component 124 may compare a metric's value at the current time to the metric's value at a prior time if the discrepancy exceeds a threshold amount (standard deviation, percentage, etc.). The recommended action may be to revert to a prior metric value. For example, the trend analysis component 124 may use a sentiment analysis machine learning model to analyze past communications of the provider user and current communications. The sentiment analysis may show that prior communications used a more confident tone than the current communication style. Thus, the recommended action may be to use a more confident tone.

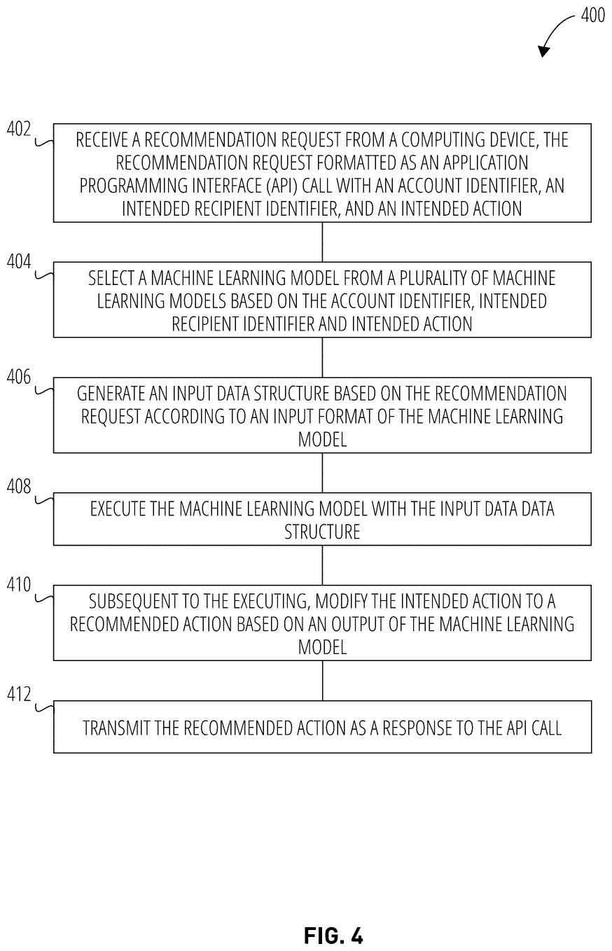

FIG. 4 is a flowchart illustrating a method to generate recommended actions according to various examples. The method is represented as a set of blocks that describe operation 402 to operation 412. The method may be embodied in a set of instructions stored in at least one computer-readable storage device of a computing device. A computer-readable storage device excludes transitory signals. In contrast, a signal-bearing medium may include such transitory signals. A machine-readable medium may be a computer-readable storage device or a signal-bearing medium.

A processing unit, which executes the set of instructions, may configure the processing unit to perform the operations illustrated in FIG. 4. The processing unit may instruct another component of a computing device to carry out the set of instructions. For example, the processing unit may instruct a network device to transmit data to another computing device or the computing device may provide data over a display interface to present a user interface. In some examples, the performance of the method may be split across multiple computing devices using a shared computing infrastructure (e.g., the processing unit encompasses multiple distributed computing devices).

In various examples, at operation 402, method 400 receives a recommendation request from a computing device, the recommendation request formatted as an application programming interface (API) call with an account identifier, an intended recipient identifier, and an intended action. In various examples, the account identifier may correspond to a provider user identifier stored in user accounts 118. The provider user identifier may be associated with information about the provider user's practice, such as number of clients, revenue, location, and other relevant data. The intended recipient identifier may correspond to a receiver user identifier stored in user accounts 118. The receiver user identifier may be linked to demographic information, communication preferences, and interaction history with the provider user. This structure enables retrieval of relevant data about the provider and receiver users when processing the recommendation request, enabling more personalized and context-aware recommendations.

In various examples, the recommendation request is received from a communication application and the intended action includes a frequency of communication with the intended recipient identifier. In various examples, the intended action includes text (e.g., a draft email, a newsletter, or a response to a client request) for transmission to the intended recipient identifier. The communication application may be an email client, a customer relationship management (CRM) tool, or a scheduling system. The email client may be a standalone application or a web-based service that allows the provider user to compose, send, and receive emails. The CRM tool may be a software application that helps manage interactions with receiver users. A scheduling system may manage appointments and meetings between the provider user and receiver users.

In various examples, at operation 404, method 400 selects a machine learning model from a plurality of machine learning models based on the account identifier, intended recipient identifier, and intended action. A location may be received as part of the recommendation request in various examples. The model may be selected based on the location (e.g., models trained on communications of practices within a particular state or city).

For example, the example production model 220 discussed in FIG. 2 may have been a general model that used the communications of many users. However, to provide more accurate recommendations, multiple machine learning models may be trained using subsets of the data. Thus, there may be a model trained on just past communications between the intended recipient identifier and account identifier. The model may be even more granular and focus specifically on communications that have a positive result (as determined by a sentiment analysis). Thus, a fine-tuned GAI may be selected that has been trained on the communication styles used by the account identifier to the intended recipient identifier that had positive outcomes.

The intended action may also dictate which machine learning model is selected. For example, if the intended action is a draft of an e-mail, a GAI model or a communication style model may be selected. Whereas if the intended action is related to the frequency of communication, a clustering machine learning model may be used that was trained on peer groups as discussed previously.

In various examples, at operation 406, method 400 generates an input data structure based on the recommendation request according to an input format of the machine learning model. The input data structure may be formatted as a vector having one or more dimensions that include data encoded from various aspects of the recommendation request. For example, the input data structure may include encoded information about the account identifier, intended recipient identifier, and intended action provided in the API call. Numerical data, such as age, may be directly used as vector components after normalization to ensure consistent scale across the dataset. Categorical data, such as communication style or intended action type, may be encoded numerically, often through one-hot encoding. The input data structure may correspond to the data structure used for the selected machine learning model.

In various examples, at operation 408, method 400 executes the machine learning model with the input data structure. The execution of the machine learning model may involve inputting the encoded vector into the selected model, which may be a neural network, k-means clustering algorithm, or another appropriate machine learning algorithm. For a neural network, the execution may involve propagating the input through multiple layers of the network and applying weights and activation functions at each node. In the case of a classification model, the output may be a vector where each element represents the probability of a possible outcome or recommended action

In various examples, at operation 410, method 400 subsequent to the executing, modifies the intended action to a recommended action based on an output of the machine learning model. The modification process may involve analyzing the output vector from the machine learning model, where each element of the vector may represent a probability or score for different possible actions or recommendations. The system may select the highest-scoring action or combine multiple high-scoring actions to formulate the recommended action.

For example, modifying the intended action may include changing the text's tone for transmission to the intended recipient identifier. This modification process may utilize natural language processing techniques to analyze the original text and generate a revised version that aligns with the recommended communication style. A fine-tuned GAI model may be used that has been trained on the intended recipient identifier's past communications to match the style that results in positive outcomes.

The modification process may also consider the intended recipient's preferences and past interactions. For example, if the machine learning model output indicates that the intended recipient responds more positively to concise communications, the system may suggest condensing the original text while maintaining key information.

In various examples, operation 410 may be used to modify a frequency of communication when the intended action is a change in the frequency (e.g., as received from customer relationship management software). Using a clustering machine learning model, the method may analyze multiple factors to determine a frequency adjustment, including historical client engagement patterns, performance metrics of similar clients (or practices) with varying communication frequencies, etc.

The machine learning model may output a recommended frequency change based on these factors. The modification process may involve quantifying the recommended frequency (e.g., “once per week” or “twice per month”), providing a qualitative recommendation (e.g., “decrease the frequency” or “maintain current frequency but increase the depth of content”), suggesting times or days for communications based on client engagement data, and recommending different frequencies for various types of communications (e.g., newsletters, portfolio updates, personal check-ins).

In various examples, at operation 412, method 400 transmits the recommended action as a response to the API call. The recommended action may be presented on a computing device associated with the account identifier.

In various examples, method 400 may further include, subsequent to the transmitting, receiving an outcome of the recommended action. This outcome may include data on how the intended recipient responded to the modified action, such as whether they engaged positively with the communication or if the adjusted frequency of communication led to improved client satisfaction. Upon receiving the outcome, the method may modify the machine learning model based on the outcome.

The process may involve updating the model's parameters or weights to reflect the new information gained from the outcome. For example, if a recommended change in communication tone resulted in a positive client response, the model may be adjusted to favor similar tone modifications in future recommendations. Modifying the machine learning model may utilize techniques such as reinforcement learning, where the model's performance is improved based on the rewards (positive outcomes) or penalties (negative outcomes) received from its actions. This continuous learning process allows the model to adapt to changing preferences over time. In various examples, the method uses a feedback loop where multiple outcomes are collected before making changes (e.g., retraining) to the model.

In various examples, method 400 may further include calculating a baseline behavior profile across multiple domains for the account identifier; determining that the intended action deviates from the baseline behavior profile more than a threshold amount; and based on the determining, transmitting a message to a computing device associated with the account identifier. The baseline behavior profile may be calculated as described in FIG. 3.

For example, if the intended action received in operation 402 is a change in frequency of communication from monthly to weekly for a specific client, the method may compare this intended action to the baseline behavior profile. The baseline profile may indicate that the account identifier typically communicates with clients of similar demographics or portfolio sizes on a bi-weekly basis. The method may then determine that the intended action deviates from the baseline behavior profile more than a threshold amount. For example, the threshold may be defined as a percentage change or a specific number of frequency intervals. For instance, if the threshold is set at a 50% change in frequency, the intended change from monthly to weekly (a 300% increase) would exceed this threshold.

Based on this determination, the method may transmit a message to a computing device associated with the account identifier. This message may be an alert notifying the account identifier of the deviation from their typical communication pattern. The alert may be delivered through various communication paths, such as an email, a push notification on a mobile device, or a visual indicator on a dashboard interface. The message may include context about the deviation, such as: “Your intended action to increase communication frequency with client [ID] from monthly to weekly represents a change from your baseline behavior profile. Typically, you communicate bi-weekly with clients of similar characteristics. Consider adjusting to a bi-weekly frequency or provide justification for the increased frequency.”

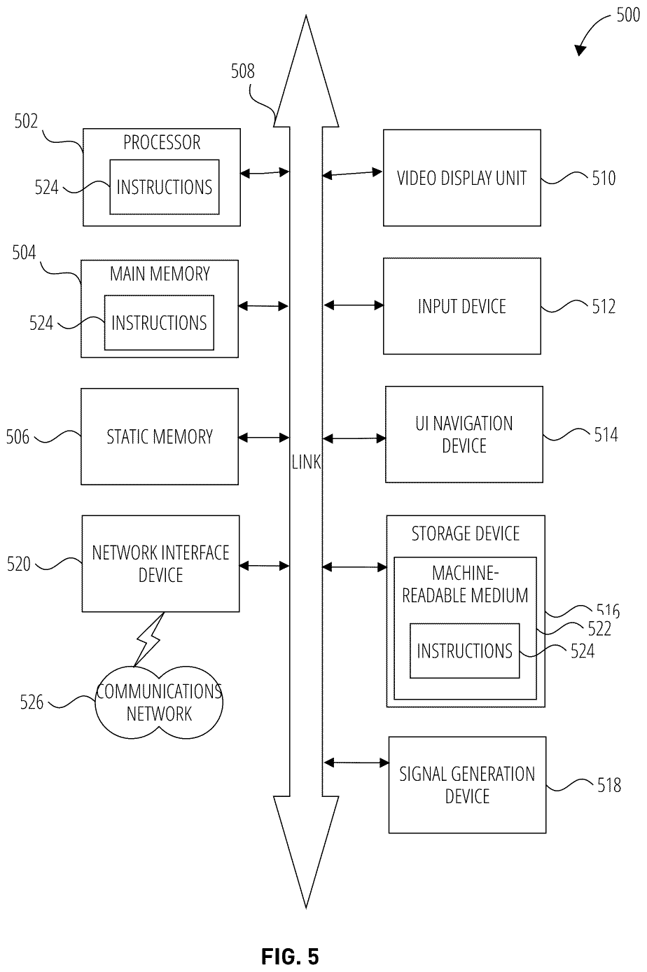

FIG. 5 is a block diagram illustrating a machine in the example form of computer system 500, within which a set or sequence of instructions may be executed to cause the machine to perform any of the methodologies discussed herein, according to an example embodiment. In alternative embodiments, the machine operates as a standalone device or may be connected (e.g., networked) to other machines. In a networked deployment, the machine may operate in the capacity of either a server or a client machine in server-client network environments, or it may act as a peer machine in peer-to-peer (or distributed) Network environments. The machine may be an onboard vehicle system, wearable device, personal computer (PC), tablet PC, hybrid tablet, personal digital assistant (PDA), mobile telephone, or any machine capable of executing instructions (sequential or otherwise) that specify actions to be taken by that machine. Further, while only a single machine is illustrated, the term “machine” includes any collection of machines that individually or jointly execute a set (or multiple sets) of instructions to perform any of the methodologies discussed herein. Similarly, the term “processor-based system” shall be taken to include any set of one or more machines that are controlled by or operated by a processor (e.g., a computer) to individually or jointly execute instructions to perform any one or more of the methodologies discussed herein

Example computer system 500 includes at least one processor 502 (e.g., a central processing unit (CPU), a graphics processing unit (GPU) or both, processor cores, compute nodes, etc.), a main memory 504, and a static memory 506, which communicate with each other via a link 508. The computer system 500 may include a video display unit 510, an input device 512 (e.g., a keyboard), and a user interface UI navigation device 514 (e.g., a mouse). In an example, the video display unit 510, input device 512, and UI navigation device 514 are incorporated into a single device housing, such as a touchscreen display. The computer system 500 may additionally include a storage device 516 (e.g., a drive unit), a signal generation device 518 (e.g., a speaker), a network interface device 520, and one or more sensors (not shown), such as a global positioning system (GPS) sensor, compass, accelerometer, or other sensors.

The storage device 516 includes a machine-readable medium 522 on which one or more sets of data structures and instructions 524 (e.g., software) embodying or utilized by any of the methodologies or functions described herein. The instructions 524 may also reside, completely or at least partially, within the main memory 504, the static memory 506, or within the processor 502 during execution thereof by the computer system 500, with the main memory 504, the static memory 506, and the processor 502 also constituting machine-readable media.

While the machine-readable medium 522 is illustrated in an example embodiment to be a single medium, the term “machine-readable medium” may include a single medium or multiple media (e.g., a centralized or distributed database or associated caches and servers) that store the instructions 524. The term “machine-readable medium” shall also be taken to include any tangible medium that is capable of storing, encoding, or carrying instructions for execution by the machine and that causes the machine to perform any one or more of the methodologies of the present disclosure or that is capable of storing, encoding or carrying data structures utilized by or associated with such instructions. The term “machine-readable medium” includes, but is not limited to, solid-state memories and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks. A computer-readable storage device may be a machine-readable medium 522 that excludes transitory signals.

The instructions 524 may be transmitted or received over a communications network 526 using a transmission medium via the network interface device 520 utilizing a transfer protocol (e.g., HTTP). Examples of communication networks include a local area network (LAN), a wide area network (WAN), the Internet, mobile telephone networks, plain old telephone (POTS) networks, and wireless data networks (e.g., Wi-Fi, 3G, and 4G LTE/LTE-A or WiMAX networks). The term “transmission medium” shall be taken to include any intangible medium that is capable of storing, encoding, or carrying instructions for execution by the machine and includes digital or analog communications signals or other intangible mediums to facilitate communication of such software.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplated are examples using any combination or permutation of those elements shown or described (or one or more aspects thereof), either with respect to a particular example (or one or more aspects thereof) or with respect to other examples (or one or more aspects thereof) shown or described herein.

What is claimed is:

1. A method comprising:
receiving a recommendation request from a computing device, the recommendation request formatted as an application programming interface (API) call with an account identifier, an intended recipient identifier, and an intended action;
selecting a machine learning model from a plurality of machine learning models based on the account identifier, intended recipient identifier and intended action;
generating an input data structure based on the recommendation request according to an input format of the machine learning model;
executing the machine learning model with the input data structure;
subsequent to the executing, modifying the intended action to a recommended action based on an output of the machine learning model;
transmitting the recommended action as a response to the API call.

2. The method of claim 1, further comprising:
subsequent to the transmitting, receiving an outcome of the recommended action; and
modifying the machine learning model based on the outcome.

3. The method of claim 1, wherein receiving the recommendation request includes receiving the recommendation request from a communication application and the intended action includes a frequency of communication with the intended recipient identifier.

4. The method of claim 1, further comprising:
calculating a baseline behavior profile across multiple domains for the account identifier;
determining that the intended action deviates from the baseline behavior profile more than a threshold amount; and
based on the determining, transmitting a message to a computing device associated with the account identifier.

5. The method of claim 1, wherein receiving the recommendation request includes receiving the recommendation request from a communication application and the intended action includes text for transmission to the intended recipient identifier.

6. The method of claim 5, wherein selecting the machine learning model from the plurality of machine learning models includes:
selecting a generative artificial intelligence model trained on past communications of the intended recipient identifier.

7. The method of claim 6, wherein modifying the intended action to the recommended action based on the output of the machine learning model includes changing a tone of the text for transmission to the intended recipient identifier.

8. The method of claim 1, wherein the recommendation request includes a location and wherein selecting the machine learning model from a plurality of machine learning models is further based on the location.

9. A non-transitory computer-readable medium comprising instructions, which when executed by a processing unit, configure the processing unit to perform operations comprising: comprising:
receiving a recommendation request from a computing device, the recommendation request formatted as an application programming interface (API) call with an account identifier, an intended recipient identifier, and an intended action;
selecting a machine learning model from a plurality of machine learning models based on the account identifier, intended recipient identifier and intended action;
generating an input data structure based on the recommendation request according to an input format of the machine learning model;
executing the machine learning model with the input data structure;
subsequent to the executing, modifying the intended action to a recommended action based on an output of the machine learning model;
transmitting the recommended action as a response to the API call.

10. The non-transitory computer-readable medium of claim 9, wherein the instructions, which when executed by the processing unit, further configure the processing unit to perform operations comprising:
subsequent to the transmitting, receiving an outcome of the recommended action; and
modifying the machine learning model based on the outcome.

11. The non-transitory computer-readable medium of claim 9, wherein receiving the recommendation request includes receiving the recommendation request from a communication application and the intended action includes a frequency of communication with the intended recipient identifier.

12. The non-transitory computer-readable medium of claim 9, wherein the instructions, which when executed by the processing unit, further configure the processing unit to perform operations comprising:
calculating a baseline behavior profile across multiple domains for the account identifier;
determining that the intended action deviates from the baseline behavior profile more than a threshold amount; and
based on the determining, transmitting a message to a computing device associated with the account identifier.

13. The non-transitory computer-readable medium of claim 9, wherein receiving the recommendation request includes receiving the recommendation request from a communication application and the intended action includes text for transmission to the intended recipient identifier.

14. The non-transitory computer-readable medium of claim 13, wherein selecting the machine learning model from the plurality of machine learning models includes:
selecting a generative artificial intelligence model trained on past communications of the intended recipient identifier.

15. The non-transitory computer-readable medium of claim 14, wherein modifying the intended action to the recommended action based on the output of the machine learning model includes changing a tone of the text for transmission to the intended recipient identifier.

16. The non-transitory computer-readable medium of claim 9, wherein the recommendation request includes a location and wherein selecting the machine learning model from a plurality of machine learning models is further based on the location.

17. A system comprising:
a processing unit; and
a non-transitory computer-readable medium comprising instructions, which when executed by the processing unit, configure the processing unit to perform operations comprising:
receiving a recommendation request from a computing device, the recommendation request formatted as an application programming interface (API) call with an account identifier, an intended recipient identifier, and an intended action;
selecting a machine learning model from a plurality of machine learning models based on the account identifier, intended recipient identifier and intended action;
generating an input data structure based on the recommendation request according to an input format of the machine learning model;
executing the machine learning model with the input data structure;
subsequent to the executing, modifying the intended action to a recommended action based on an output of the machine learning model;
transmitting the recommended action as a response to the API call.

18. The method of claim 17, wherein the instructions, which when executed by the processing unit, further configure the processing unit to perform operations comprising:
subsequent to the transmitting, receiving an outcome of the recommended action; and
modifying the machine learning model based on the outcome.

19. The method of claim 17, wherein receiving the recommendation request includes receiving the recommendation request from a communication application and the intended action includes a frequency of communication with the intended recipient identifier.

20. The method of claim 17, wherein the instructions, which when executed by the processing unit, further configure the processing unit to perform operations comprising:
calculating a baseline behavior profile across multiple domains for the account identifier;
determining that the intended action deviates from the baseline behavior profile more than a threshold amount; and
based on the determining, transmitting a message to a computing device associated with the account identifier.
